(19) United States
(12) Patent Application Publication
(10) Pub. No.: US 2009/0205196 A1
(43) Pub. Date: Aug. 20, 2009

(54) SELF-HEATING EFFECTS DURING OPERATION OF THERMALLY-TRIMMABLE RESISTORS

(76) Inventors: Oleg Grudin, Montreal (CA); Leslie M. Landsberger, Montreal (CA)

Correspondence Address: OGILVY RENAULT LLP, 1, Place Ville Marie, SUITE 2500, MONTREAL, QC, H3B 1R1, CA

(21) Appl. No.: 12/294,087

(22) PCT Filed: Mar. 23, 2007
(86) PCT No.: PCT/CA2007/000481

§ 371 Date: Sep. 23, 2008

Related U.S. Application Data
(60) Provisional application No. 60/784,784, filed on Mar. 23, 2006.

(51) Int. Cl. H01C 17/232; H01C 10/00

(52) U.S. Cl. 29/612; 338/195

(57) ABSTRACT

The thermal isolation of a thermally-trimmable resistor has a direct impact on temperature rise. It is possible to design the thermal isolation of the portions of a compound resistor to minimize or optimize the resistance variation of the overall compound resistor. The resistance variation of the overall compound resistor due to self-heating of its portions can be reduced or optimized, by designing different thermal isolation for each of the portions, such that compensation and/or optimization can occur. Furthermore, one can also design such different thermal isolation of the portions of a compound resistor to minimize resistance variation over a trim range of a compound resistor due to self-heating.

### CROSS-REFERENCE TO RELATED APPLICATIONS

This application claims priority of U.S. Provisional Patent Application No. 60/784,784 filed on Mar. 23, 2006.

### TECHNICAL FIELD

The invention relates to resistors and resistor networks which are electro-thermally trimmable, and more specifically, to the effects of self-heating during operation of these resistors.

### BACKGROUND OF THE INVENTION

In working with resistors referred to as “precision resistors”, it is advantageous to have the capability to precisely adjust the resistance value. It may also be advantageous to precisely control or adjust the temperature coefficient of resistance (TCR) of such a resistor. Resistor trimming can be achieved by heating using electric current pulses passed through the resistor itself or through an adjacent auxiliary heater. Thermal trimming directly modifies the physical properties of the material such as resistivity and TCR.

Joint and independent adjustment of resistance and TCR can be achieved for compound resistors containing a first portion with a first resistance value and a positive TCR and a second portion with a second resistance value and a negative TCR. Independent trimming of these two portions of the compound resistor results in the adjustment of the total resistance and of the TCR of the compound resistor.

Near-zero TCR of the resistor is often desirable because it gives near-zero resistance drift with variation of ambient temperature. One of the problems of compound resistors consisting of two portions with positive and negative TCR is that near-zero TCR of the whole resistor does not mean near-zero TCR of each individual portion.

Non-zero TCR values generate a problem during operation of these types of resistors. When an electric current passes through the resistor, a self-heating effect causes a temporary change in resistance. The amount of the change depends on the overheating temperatures of each resistive portion. This can have a serious impact on the overall operation of the circuit due to the change of resistance value of each part of the compound resistor during operation.

### SUMMARY OF THE INVENTION

The thermal isolation of a thermally-trimmable resistor has a direct impact on temperature rise. It is possible to design the thermal isolation of the portions of a compound resistor to minimize or optimize the resistance variation of the overall compound resistor. The resistance variation of the overall compound resistor due to self-heating of its portions can be reduced or optimized, by designing different thermal isolation for each of the portions, such that compensation and/or optimization can occur. Furthermore, one can also design such different thermal isolation of the portions of a compound resistor to minimize resistance variation over a trim range of a compound resistor due to self-heating.

In accordance with a first broad aspect of the present invention, there is provided a method for providing a trimmable compound resistor, the method comprising: selecting materials to form a compound resistor having at least a first portion and a second portion, at least the first portion including a first resistor that is thermally trimmable and has a first resistivity and a first temperature coefficient of resistance α0, the second portion including at least a second resistor having a second resistivity and a second temperature coefficient of resistance β₀; determining how an overall resistance of the compound resistor varies during operation thereof due to self-heating effects caused by non-zero values for α₀ and β₀ as a function of a thermal isolation of the first portion G₁ and a thermal isolation of the second portion G₂; and selecting values G₁ and G₂, and resistance values R₁ and R₂ for the first and second portions to reduce the self-heating effect.

In accordance with a second broad aspect of the present invention, there is provided a thermally-trimmable compound resistor comprising a first portion composed of a first resistor that is thermally trimmable and has a first resistivity, a first temperature coefficient of resistance value α₀, and first thermal isolation G₁; and a second portion composed of at least a second resistor having a second resistivity, a second temperature coefficient of resistance value β₀, and a second thermal isolation G₂; and a ratio of G₁ to G₂ compensating for a change in resistance value ΔR induced by a self-heating effect of the compound resistor during operation, ΔR corresponding to an overall change in resistance for the compound resistor during operation.

In accordance with a third broad aspect of the present invention, there is provided a method for providing a trimmable compound resistor, the method comprising: selecting materials to form a compound resistor having at least a first portion and a second portion, at least the first portion including a first resistor that is thermally trimmable and has a first resistivity, a first temperature coefficient of resistance α₀, and a trimming-induced shift of temperature coefficient γ₁, which defines a change in temperature coefficient of resistance per fraction of trimming x of the first resistivity, the second portion including at least a second resistor having a second resistivity, and a second temperature coefficient of resistance β₀; determining how a temperature coefficient of resistance (TCR) of the compound resistor changes as at least the first portion is trimmed, by generating a function of the TCR versus trim-fraction x, with R₁ and R₂ as variable parameters and α₀, β₀, and γ₁ as fixed parameters; determining how an overall resistance of the compound resistor varies during operation thereof due to self-heating effects caused by non-zero values for α₀ and β₀ as a function of a thermal isolation of the first portion G₁ and a thermal isolation of the second portion G₂; and selecting values for R₁ and R₂ or a ratio thereof, and for G₁ and G₂ or a ratio thereof, to incorporate an effect of the γ₁ and reduce a self-heating effect on the compound resistor.

The term “compensating” should be understood as meaning to reduce/minimize or eliminate an effect thereof. In addition, what is meant by “fixed parameters” is that these values are not selected by the user but are intrinsic to the material. However, they are not necessarily constant and may vary, for example, with temperature or as a function of trim-fraction or time.

### BRIEF DESCRIPTION OF THE DRAWINGS

Further features and advantages of the present invention will become apparent from the following detailed description, taken in combination with the appended drawings, in which:

FIG. 1 is a schematic of a compound resistor consisting of two parts connected in series, as per an embodiment of the present invention;

FIG. 2 is a graph showing normalized self-heating-induced resistance change (ΔR/R), of a compound resistor configured as shown in FIG. 1 vs. trimming of the resistance value of its trimmable portion (R₁), for several different ratios of G₂/G₁=0, 3.94, 3; and

FIG. 3 is a graph showing normalized self-heating-induced resistance change (ΔR/R), of a compound resistor consisting of two trimmable portions vs. trimming fractions x, y, of the resistance value of each trimmable portion R₁(x), R₂(y), for several different ratios of G₂/G₁=1, 1/3, 1/5.

It will be noted that throughout the appended drawings, like features are identified by like reference numerals.

### DETAILED DESCRIPTION

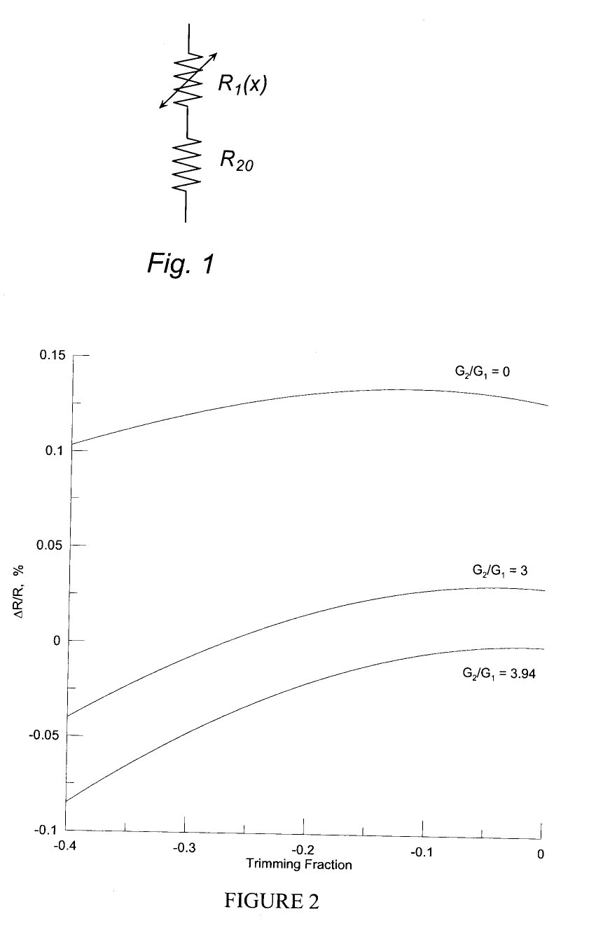

Consider the series compound resistor shown in FIG. 1 with two resistive portions R₁ and R₂, having corresponding thermal isolation G₁ and G₂ (measured in K/mW, meaning average increase in temperature in the resistor per mW of power dissipated in that resistor). Assume that one of the portions is thermally-trimmable, in this case R₁. Electric current I passing through the series compound resistor results in resistance changes in each of the two portions, and in the whole resistor:

ΔR₁(x)=R₁(x)[α(x)ΔT₁]=R₁(x)[α(x)I²R₁(x)G₁],

ΔR₂=R₂₀[βₒΔT₂]=R₂₀[βₒI²R₂₀G₂],

where ΔT₁ and ΔT₂ are overheating temperatures of each of the two portions due to power I²R₁ and I²R₂ dissipated in them, where x is the trim-fraction of the trimmable portion R₁, where α(x) is the TCR of R₁ as x varies, and where βₒ is the TCR of R₂. For the overall series-connected resistor R₁(x)+R₂, the self-heating-induced resistance modulation is

ΔR(x)=ΔR₁(x)+ΔR₂=I²[α(x)G₁R₁²(x)+βₒG₂R₂₀²].

In practice, the thermal isolations G₁ and G₂ do not vary significantly with thermal trimming. Since G₁ and G₂ can only be positive, reduction of self-heating-induced ΔR by compensation of TCR is only possible if α(x) and βₒ have opposite signs. In the case of this first example described above, for untrimmed resistors ΔR is zero when G₁/G₂=−[R₂₀²/R₁₀²]*[βₒ/αₒ], where αₒ is the TCR of R₁ when untrimmed.

Thus, untrimmed compound resistors where one portion has positive TCR and one portion has negative TCR can be self-heating compensated by setting the thermal isolation according to the condition in the above paragraph. For example, if portion R₁=2000Ω has TCR αₒ=+450 ppm/K, and portion R₂=1000Ω has TCR βₒ=−1350 ppm/K, then one can compensate the self-heating effect by creating G₁/G₂=−[R₂₀²/R₁₀²]*[βₒ/αₒ]=[1/4]*[1350/450]=0.75.

Designed ratios of thermal isolation G₁/G₂ of a pair of resistance elements can be obtained in practice in a variety of ways. If the two portions are simple integrated resistors made from surface films on a substrate, then one can arrange materials of different thermal conductivities to surround each of the two portions. Or one may place the two resistance portions on insulating films of different thicknesses, thereby creating different thermal isolation from the substrate.

One may create special film-based thermal isolation structures (e.g. US2005/0258990, Babcock et al), with known or measured thermal isolation.

If the two portions are implemented in identical thermally-isolated micro-platforms (each having thermal isolation, for example 30 K/mW), then one can arrange R₁ on 4 such identical units, while arranging R₂ on 3 such identical units. For example if 1 mA is passed through this series-connected compound resistor, the 2 mW of power dissipated in R₁ is divided into 4 micro-platforms (0.5 mW in each unit), while the 1 mW of power dissipated in R₂ is divided into 3 micro-platforms (0.33 mW in each unit). Thus R₁ experiences a temperature rise of 15K, (and a resistance increase of 6750 ppm), while R₂ experiences a temperature rise of 10K (and a resistance decrease of 13500 ppm). Since R₁=2R₂, 2*6750+(−13500)=0, and the self-heating-induced resistance change is compensated.

If one is not limited to using identical thermally-isolated micro-platforms, one may use micro-platforms which have different thermal isolation values. For example, one may implement the thermally-isolated micro-platforms as two-armed cantilevers (e.g. as shown in WO03023794), where the length and width of the supporting arms can be varied, or one can add or subtract material of known thermal conductivity to the supporting arms. For example, if the desired G₁/G₂ ratio is 3.92 (instead of a more-easily implementable “3” or “4”), then one may use 4 cantilevers for G₂, and use 1 cantilever for G₁, and decrease the thermal isolation of R₁ slightly by adding an appropriate slab of thermally-conductive material in the supporting arms of its cantilever.

If one has waisted structures available (PCT/CA2005/001726), one may use such structures to implement intermediate thermal isolation values. The above variety of ways are intended to be illustrative. One skilled in the art of thermal properties of materials used in integrated circuits is expected be able to apply such techniques within the context of his/her application.

Another goal of this invention is to minimize self-heating-induced resistance modulation in thermally-trimmable resistors over a trim range of interest. Zero self-heating-induced resistance modulation is theoretically possible over a trim range, in certain restrictive conditions. The two resistive portions R₁ and R₂ of the compound resistor must be designed such that their thermal isolation complies with the condition: G₁/G₂=−[R₂²(y)/R₁²(x)]*[β(y)/α(x)], over the trim ranges (x,y) of interest.

In practice, it may be difficult to obtain variations of resistance and TCR over a trim range such that this ratio is exactly maintained, since it is unlikely that thermal trimming would appreciably change the thermal isolations G₁, G₂. However, awareness and simulation using this equation should allow minimization or optimization of self-heating-induced resistance changes over a trim range of interest.

For example, in the case of a series-connected compound resistor, where only R₁ is thermally-trimmable, then zero self-heating-induced resistance modulation is theoretically possible over a trim range only when the two resistive portions R₁ and R₂ of the compound resistor are designed so that their thermal isolation complies with a condition:

G₁/G₂=−[R₂₀²/R₁²(x)][βₒ/α(x)], over the trim range (x) of interest.

In practice, it is problematic to keep ΔR=0 over a significant trim range, since the variations α(x) may vary arbitrarily. For example, α(x) may be approximately of the form α(x)=αₒ+γ₁(x) x. Therefore, a typical goal is to keep ΔR as small as possible over the desired trim range, and the “optimum” may vary delicately depending on the criteria and trim range.

As an example, consider a compound resistor consisting of a first trimmable portion with initial resistance R₁₀=10000Ω, TCR α₀=320 ppm/K and a second un-trimmable portion connected in series, having resistance R₂₀=0.25·R₁₀=2500Ω and TCR β₀=−1300 ppm/K. The first portion is located on a thermally isolated platform with thermal isolation G₁₌₅₀ K/mW. During trimming, resistance of the first resistor and its TCR vary as:

R₁(x)=R₁₀(1+x) α(x)=α₀−γ₁(1+ξx)x

where x (−0.4<x<0) is the trimming fraction of R₁, γ₁=700 ppm/K is TCT (coefficient of variation of TCR with trim-fraction), and ξ=1 is a coefficient describing non-linear variation of TCR vs. trim fraction. When electric current passes through this compound resistor, the self-heating effect causes a change of resistance. The amount of the change depends on overheating temperature of each resistive portion with positive and negative TCR. Assume that the second resistor has thermal isolation G₂. FIG. 2 shows the variation of resistance of the described compound resistor, with an applied current of 0.1 mA, over the trimming range from x=0 to x=−0.4.

The greatest resistance variation corresponds to the case when G₂=0 (no self-heating of the second resistance portion). When the second portion is placed on a thermally isolated platform with a thermal isolation G₂ 3.94 times higher than G₁ (calculated from

$$\frac{{G}_{1}}{{G}_{2}} = - {k}^{2} \frac{{β}_{0}}{{α}_{0}} ) ,$$

no resistance change occurs at x=0. However, trimming of the portion R₁ decreases its resistance value, which results in reduction of its self-heating and unbalances the self-heating compensation such that the overall self-heating-induced ΔR is negative, as seen in the figure. To reduce resistance change due to self-heating over the whole trimming range, one may adjust the ratio G₂/G₁ to a different value. The remaining curve in FIG. 2 shows an example where G₂/G₁=3, and self-heating-induced ΔR remains smaller than +/−0.05% over the entire 40%-down trim-range.

Also, the thermal isolation ratio may have limited selection. For example, if it is desired to use substantially the same thermally-isolated platforms, which each have approximately the same thermal isolation, one may approximate the ratio 1:3 by using 3 platforms for R₁ and 1 platform for R₂. (R₁ has effectively 3 times less thermal isolation, since its dissipated power is divided among three platforms, leading to three times less temperature rise for a given power input.)

There may be different types of constraints impinging on the design problem. Often, α(x) and βₒ are given, fixed due to other (materials-availability) constraints. Perhaps even R₁₀, R₁(x) and R₂₀ may be fixed due to constraints related to the variation of TCR with trim in the compound resistor. If these types of prior constraints are treated as a higher priority than the compensation of self-heating, then a simple procedure is mandated. If one takes as given α(x) βₒ, R₁₀, R₁(x) and R₂₀ then one simply works with the resulting formula G₁/G₂=−[R₂₀²/R₁²(x)]*[βₒ/α(x)], over the trim range (x) of interest. This formula may be a closed-form mathematical prescription, or may reduce to an experimentally-generated lookup table at discrete values of x, perhaps with uncertainties at each value of x. By examining the result of this formula at a set of x-values, one simply chooses and implements the G₁/G₂ ratio which meets (or approximates) one's criteria of “optimum” over one's desired trim range.

For example, if the G₁/G₂ ratio varies from 2.5 to 3.8 over the trim range of interest, then one may want to choose a ratio of 3.2, and implement such a number using one or more of the methods described earlier. On the other hand, one may also decide that a ratio of 3.0 is sufficient, and use identical cantilevers in a ratio of 1:3.

If the parameters α(x) βₒ, R₁₀, R₁(x) and R₂₀ are not necessarily fixed, then one may also co-design trimming behavior with compensation of self-heating. If, for example α(x), βₒ, were fixed due to materials-availability constraints, but R₁₀ and R₂₀ were free to be varied somewhat, then these resistances could be varied as well as G₁/G₂ to obtain a better self-heating behavior over the desired trim range.

Consider a compound resistor with two resistive portions R₁ and R₂, connected in parallel and having corresponding thermal isolation G₁ and G₂ (measured in K/mW). Voltage U applied to the compound resistor results in resistance change of the two portions and the whole resistor:

$$\begin{matrix}Δ {R}_{1} ( x ) = {R}_{1} ( x ) ( α ( x ) Δ {T}_{1} ) \\ = {R}_{1} ( x ) ( α ( x ) {G}_{1} {U}^{2} \text{/} {R}_{1} ( x ) ) \\ = α ( x ) {G}_{1} {U}^{2}\end{matrix}$$

$$\begin{matrix}Δ {R}_{2} = {R}_{20} ( {β}_{0} Δ {T}_{2} ) \\ = {R}_{20} ( {β}_{0} {G}_{2} {U}^{2} \text{/} {R}_{20} ) \\ = {β}_{0} {G}_{2} {U}^{2}\end{matrix}$$

$$\begin{matrix}Δ R ( x ) = \frac{{R}_{20}^{2} Δ {R}_{1} ( x ) + {{R}_{1} ( x )}^{2} Δ {R}_{20}}{{( {R}_{1} ( x ) + {R}_{20} )}^{2}} \\ = \frac{{U}^{2} ( {R}_{20}^{2} α ( x ) {G}_{1} + {{R}_{1} ( x )}^{2} {β}_{0} {G}_{2} )}{{( {R}_{1} ( x ) + {R}_{20} )}^{2}}\end{matrix}$$

In this parallel-connected case, zero self-heating-induced resistance modulation is theoretically possible when the two resistive portions R₁ and R₂ of the compound resistor are designed so that their thermal isolation complies with a condition:

G₁/G₂=−[R₁(X)²/R₂₀²][βₒ/α(x)]

which again only has physical meaning if α(x) and βₒ have opposite signs.

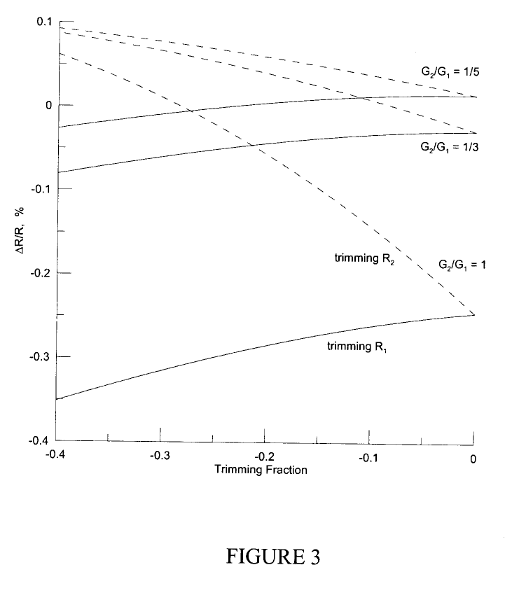

The above analyses hold for the case where one portion is trimmed while the other is not. It is also possible to design a compound thermally-trimmable resistor where both portions may be trimmed, having (in general) different TCR and TCT. In this case, the self-heating-induced resistance change may vary differently depending on which portion is trimmed. FIG. 3 shows several possible results, as a function of trimming fraction of one resistance portion, where the two portions are connected in series, and have as-manufactured resistance ratio of 1:1. One can see that if the two portions have equal thermal isolation (G₂/G₁=1), then before any trimming there is significant self-heating-induced ΔR/R, while trimming portions R₁ and R₂ have quite different effects on ΔR/R. When the resistance portion, R₂, having large negative TCR, is given 1/3 of the thermal isolation, then both the absolute ΔR/R and its change with trim are significantly reduced. When the R₂ resistance portion is given a 1/5 of the thermal isolation, the change with trim is further reduced, but the absolute ΔR/R is increased slightly.

The embodiment(s) of the invention described above is(are) intended to be exemplary only. The scope of the invention is therefore intended to be limited solely by the scope of the appended claims.

1. A method for providing a trimmable compound resistor, the method comprising:
selecting materials to form a compound resistor having at least a first portion and a second portion, at least said first portion including a first resistor that is thermally trimmable and has a first resistivity and a first temperature coefficient of resistance α₀, said second portion including at least a second resistor having a second resistivity and a second temperature coefficient of resistance β₀;
determining how an overall resistance of said compound resistor varies during operation thereof due to self-heating effects caused by non-zero values for said α₀ and β₀ as a function of a thermal isolation of said first portion G₁ and a thermal isolation of said second portion G₂; and
selecting values for R₁ and R₂ or a ratio R₁/R₂, and for G₁ and G₂ or a ratio G₁/G₂, for said first and second portions to reduce said self-heating effect.

2. A method as claimed in claim 1, further comprising arranging materials of different thermal conductivities to surround said first portion and said second portion in order to obtain said one of said G₁ and G₂ and a ratio G₁/G₂.

3. A method as claimed in claim 1, further comprising placing said first portion and said second portion on insulating films of different thicknesses in order to obtain said one of said G₁ and G₂ and a ratio G₁/G₂.

4. A method as claimed in claim 1, further comprising distributing said first portion and said second portion on a different number of thermally-isolated micro-platforms in order to obtain said one of said G₁ and G₂ and a ratio G₁/G₂.

5. A method as claimed in claim 4, wherein said distributing said first portion and said second portion on a different number of thermally-isolated micro-platforms comprises distributing on micro-platforms each having a substantially same thermal isolation.

6. A method as claimed in claim 1, further comprising distributing said first portion on a plurality of thermally-isolated micro-platforms each having a first thermal isolation and distributing said second portion on a plurality of thermally-isolated micro-platforms each having a second thermal isolation, wherein said first thermal isolation and said second thermal isolation are different.

7. A method as claimed in claim 1, further comprising embedding said first portion and said second portion in thermally-isolated micro-platforms having different thermal isolation values in order to obtain said one of said G₁ and G₂ and a ratio G₁/G₂.

8. A method as claimed in claim 7, wherein said different thermal isolation values are obtained by varying a number of supporting arms of said thermally-isolated micro-platforms.

9. A method as claimed in claim 7, wherein said different thermal isolation values are obtained by varying a length and width of supporting arms of said thermally-isolated micro-platforms.

10. A method as claimed in claim 1, further comprising embedding said first portion and said second portion in waisted thermally-isolated micro-platforms having different waist sizes in order to obtain said one of said G₁ and G₂ and a ratio G₁/G₂.

11. A method as claimed in claim 1, wherein said selecting a ratio G₁/G₂ comprises selecting said ratio such that it equals −[R₂²(y)/R₁²(x)]*[β(y)/α(x)] over trim ranges (x,y) of interest.

12. A method as claimed in claim 1, further comprising further reducing resistance change due to self-heating over a trimming range of interest by adjusting said ratio G₁/G₂ to a different value.

13. A method as claimed in claim 1, wherein said selecting a ratio G₁/G₂ comprises selecting said ratio such that it equals −[R₂₀²/R₁²(x)]*[βₒ/α(x)] over a trim range (x) of interest.

14. A method as claimed in claim 1, wherein said selecting a ratio G₁/G₂ comprises selecting said ratio based on experimental observations of self-heating behaviour at discrete values of trim-fraction x.

15. A method as claimed in claim 1, wherein said selecting a ratio G₁/G₂ comprises selecting said ratio such that it equals −[R₂₀²/R₁₀²]*[βₒ/αₒ].

16. A method as claimed in claim 1, wherein said selecting a ratio G₁/G₂ comprises selecting said ratio such that it equals −[R₁(x)²/R₂₀²] [βₒ/α(x)].

17. A method as claimed in claim 1, wherein said selecting values comprises selecting values to optimize said ratio for an entire trimming range available for said thermally-trimmable compound resistor.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method for providing a trimmable compound resistor, the method comprising:
selecting materials to form a compound resistor having at least a first portion and a second portion, at least said first portion including a first resistor that is thermally trimmable and has a first resistivity, a first temperature coefficient of resistance α₀, and a trimming-induced shift of temperature coefficient γ₁, which defines a change in temperature coefficient of resistance per fraction of trimming x of said first resistivity, said second portion including at least a second resistor having a second resistivity, and a second temperature coefficient of resistance β₀;
determining how a temperature coefficient of resistance (TCR) of said compound resistor changes as at least said first portion is trimmed, by generating a function of said TCR versus trim-fraction x, with R₁ and R₂ as variable parameters and α₀, β₀, and γ₁ as fixed parameters;
determining how an overall resistance of said compound resistor varies during operation thereof due to self-heating effects caused by non-zero values for said α₀ and β₀ as a function of a thermal isolation of said first portion G₁ and a thermal isolation of said second portion G₂; and
selecting values for R₁ and R₂ or a ratio R₁/R₂, and for G₁ and G₂ or a ratio G₁/G₂, to incorporate an effect of said γ₁ and reduce a self-heating effect on said compound resistor.

34. A method as claimed in claim 33, further comprising arranging materials of different thermal conductivities to surround said first portion and said second portion in order to obtain said one of said G₁ and G₂ and a ratio G₁/G₂.

35. A method as claimed in claim 33, further comprising placing said first portion and said second portion on insulating films of different thicknesses in order to obtain said one of said G₁ and G₂ and a ratio G₁/G₂.

36. A method as claimed in claim 33, further comprising distributing said first portion and said second portion on a different number of thermally-isolated micro-platforms in order to obtain said one of said G₁ and G₂ and a ratio G₁/G₂.

37. A method as claimed in claim 36, wherein said distributing said first portion and said second portion on a different number of thermally-isolated micro-platforms comprises distributing on micro-platforms each having a substantially same thermal isolation.

38. A method as claimed in claim 33, further comprises distributing said first portion on a plurality of thermally-isolated micro-platforms each having a first thermal isolation and distributing said second portion on a plurality of thermally-isolated micro-platforms each having a second thermal isolation, wherein said first thermal isolation and said second thermal isolation are different.

39. A method as claimed in claim 33, further comprising embedding said first portion and said second portion in thermally-isolated micro-platforms having different thermal isolation values in order to obtain said one of said G₁ and G₂ and a ratio G₁/G₂.

40. A method as claimed in claim 39, wherein said different thermal isolation values are obtained by varying a number of supporting arms of said thermally-isolated micro-platforms.

41. method as claimed in claim 39, wherein said different thermal isolation values are obtained by varying a length and width of supporting arms of said thermally-isolated micro-platforms.

42. A method as claimed in claim 33, further comprising embedding said first portion and said second portion in waisted thermally-isolated micro-platforms having different waist sizes in order to obtain said one of said G₁ and G₂ and a ratio G₁/G₂.

43. A method as claimed in claim 33, wherein said selecting a ratio G₁/G₂ comprises selecting said ratio such that it equals −[R₂²(y)/R₁²(x)]*[β(y)/α(x)] over trim ranges (x,y) of interest.

44. A method as claimed in claim 33, wherein said selecting a ratio G₁/G₂ comprises selecting said ratio such that it equals −[R₂₀²/R₁²(x)]*[βₒ/α(x)] over a trim range (x) of interest.

45. A method as claimed in claim 33, wherein said selecting a ratio G₁/G₂ comprises selecting said ratio such that it equals −[R₂₀²/R₁₀²]*[βₒ/αₒ].

46. A method as claimed in claim 33, wherein said selecting a ratio G₁/G₂ comprises selecting said ratio such that it equals −[R₁(x)²/R₂₀²] [βₒ/α(x)].

47. A method as claimed in claim 33, wherein said selecting values comprises selecting values to optimize said ratio for an entire trimming range available for said thermally-trimmable compound.

48. A method as claimed in claim 33, further comprising further reducing resistance change due to self-heating over a trimming range of interest by adjusting said ratio G₁/G₂ to a different value.

49. A method as claimed in claim 33, wherein said selecting a ratio G₁/G₂ comprises selecting said ratio based on experimental observations of self-heating behaviour at discrete values of trim-fraction x.
